(19) United States
(12) Patent Application Publication
(10) Pub. No.: US 2018/0284496 A1
(43) Pub. Date: Oct. 4, 2018

(54) DISPLAY APPARATUS

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,698

(22) PCT Filed: Aug. 16, 2017
(86) PCT No.: PCT/CN2017/097606

§ 371 Date: Sep. 26, 2017

(30) Foreign Application Priority Data
Mar. 30, 2017 (CN) 201710203355.4

(51) Int. Cl. G02F 1/137; G02F 1/1347; G02F 1/133

(52) U.S. Cl. CPC G02F 1/137; G02F 1/13476; H01J 17/00; G02F 2001/13756; G02F 2201/44; G02F 1/13306

(57) ABSTRACT

This application provides a display apparatus, including a display panel, including a plurality of image pixels arranged in arrays; and a liquid crystal dimmer panel, disposed on the display panel, where the liquid crystal dimmer panel has a transparent state and a scattering state, and in the transparent state, the liquid crystal dimmer panel allows an image of the image pixel to be directly viewed from the front side, and in the scattering state, the liquid crystal dimmer panel allows a light emitted by the image pixel to be refracted for adjustment.

### BACKGROUND

### Technical Field

This application relates to the field of image display device technologies, and in particular, to a display and a viewing angle color distortion mitigation method therefor.

### Related Art

Currently, most large-size liquid crystal display (LCD) panels are made by using a negative type vertical alignment (VA) liquid crystal technology or an in-plane switching (IPS) liquid crystal technology. The VA liquid crystal technology has advantages of high production efficiency and low manufacturing costs over the IPS liquid crystal technology. However, in terms of optical properties, compared with the IPS liquid crystal technology, the VA liquid crystal technology has relatively obvious disadvantages in optical properties. However, in terms of commercial application, the large-size liquid crystal panels particularly need to be presented at a relatively large viewing angle. Because of the problem of viewing angle color distortion existing in an LCD panel using the VA liquid crystal technology, the large-size liquid crystal panels usually cannot meet application requirements in the market.

Generally, the VA liquid crystal technology usually further divides each subpixel in an image pixel group into primary pixels and secondary pixels, and resolves the problem of viewing angle color distortion by spatially applying different drive voltages to the primary pixels and the secondary pixels. However, for such a pixel design, a metal wiring or thin film transistor (TFT) component usually needs to be further designed to drive the secondary pixels, causing a transparent opening area to be wasted. This not only affects transmittance of the LCD panel, but also increases manufacturing costs of a backlight module.

### SUMMARY

An objective of this application is to provide an LCD and a viewing angle color distortion mitigation method therefor.

To achieve the foregoing objective, technical solutions of this application are as follows: A display apparatus comprises:

a display panel, comprising a plurality of image pixels arranged in arrays; and

a liquid crystal dimmer panel, disposed on the display panel, where the liquid crystal dimmer panel has a transparent state and a scattering state, and in the transparent state, the liquid crystal dimmer panel allows an image of the image pixel to be directly viewed from the front side, and in the scattering state, the liquid crystal dimmer panel allows a light emitted by the image pixel to be refracted for adjustment.

This application further provides an LCD, comprising a backlight module; an LCD panel, where the LCD panel and the backlight module are disposed in a laminated manner, a plurality of image pixel groups is disposed in arrays on the LCD panel, the image pixel group comprises a plurality of image pixels; and a liquid crystal dimmer panel, where the liquid crystal dimmer panel and the LCD panel are disposed in a laminated manner, and the LCD panel is located between the backlight module and the liquid crystal dimmer panel, and controls drive voltages of the liquid crystal dimmer panel at locations relative to different image pixel groups, to control liquid crystal molecules in the liquid crystal dimmer panel to perform viewing angle light energy adjustment.

Further, a plurality of dimming pixels is disposed on the liquid crystal dimmer panel, and the drive voltage is a drive voltage of each of the dimming pixels on the liquid crystal dimmer panel.

Further, each of the dimming pixels is disposed in a one-to-one correspondence with each image pixel group on the LCD panel.

Further, each of the dimming pixels is disposed in a one-to-one correspondence with each image pixel in the image pixel group.

Further, a transparent conductive film is disposed on both opposite surfaces of the liquid crystal dimmer panel, and drive voltages of the liquid crystal dimmer panel at locations relative to different image pixel groups are controlled by means of wiring of the transparent conductive film, to control liquid crystal molecules in the liquid crystal dimmer panel to perform viewing angle light energy adjustment.

Further, a backlight module provides a backlight for the LCD panel, and the backlight is a collimated light illuminating the LCD panel.

Further, the LCD further comprises a signal modem, configured to modulate/demodulate a picture signal received by the display apparatus, and a controller electrically connected to the signal modem, where the controller controls a drive voltage of the image pixel of the display panel and a drive voltage of the dimming pixel of the liquid crystal dimmer panel according to the signal modulated/demodulated by the signal modem.

Further, the LCD further comprises a human eye tracking apparatus electrically connected to the controller and configured to track and determine a location of an eye of a viewer relative to the display apparatus.

Further, the human eye tracking apparatus is a charge coupled device (CCD) location detection apparatus.

Further, the display panel is an organic light-emitting diode (OLED) display panel.

Further, the display panel is a light-emitting diode (LED) display panel.

Further, the display panel is a plasma display panel (PDP).

Further, the display panel is a field emission display panel.

Further, the display panel is a carbon nanotube display panel, or an e-ink display panel.

An LCD provided by this application comprises an LCD panel, a liquid crystal dimmer panel, and a backlight module, where the backlight module is configured to illuminate the LCD panel, so that the LCD panel displays an image. Because the liquid crystal dimmer panel is disposed above the LCD panel, drive voltages of the liquid crystal dimmer panel at locations relative to different image pixel groups are controlled, to change an arrangement status of liquid crystal molecules in the liquid crystal dimmer panel, so that the liquid crystal molecules in the liquid crystal dimmer panel perform viewing angle light energy adjustment, thereby achieving an effect of homogeneous color from all viewing angles, and further reducing a viewing angle color distortion of an LCD using a VA liquid crystal technology.

Another technical solution of this application is a viewing angle color distortion mitigation method for an LCD, comprising the following steps:

providing a backlight module, an LCD panel, and a liquid crystal dimmer panel;

performing backlight illumination on an image pixel group in the LCD panel by using the backlight module; and

disposing the liquid crystal dimmer panel on the LCD panel, and controlling drive voltages of the liquid crystal dimmer panel at locations relative to different image pixel groups, to control liquid crystal molecules in the liquid crystal dimmer panel to perform viewing angle light energy adjustment.

In the viewing angle color distortion mitigation method for a display provided by this application, because the liquid crystal dimmer panel is disposed on the display panel, drive voltages of the liquid crystal dimmer panel at locations relative to different image pixel groups are controlled, to change an arrangement status of liquid crystal molecules in the liquid crystal dimmer panel, so that the liquid crystal molecules in the liquid crystal dimmer panel perform viewing angle light energy adjustment.

### BRIEF DESCRIPTION OF THE DRAWINGS

FIG. 1 is a first schematic structural exploded view of an LCD according to an embodiment of this application;

FIG. 2 is a second schematic structural exploded view of an LCD according to an embodiment of this application;

FIG. 3 is a third schematic structural exploded view of an LCD according to an embodiment of this application;

FIG. 4 is a schematic diagram of an ON state of a switch of a power supply of a liquid crystal dimmer panel of an LCD according to an embodiment of this application;

FIG. 5 is a schematic diagram of an OFF state of a switch of a power supply of a liquid crystal dimmer panel of an LCD according to an embodiment of this application; and

FIG. 6 is a schematic diagram of a display apparatus according to an embodiment of this application.

### DETAILED DESCRIPTION

The following describes in detail embodiments of this application. Examples of the embodiments are shown in the accompanying drawings, where reference signs the same or similar from beginning to end represent same or similar components or components having same or similar functions. The following embodiments described with reference to the accompanying drawings are exemplary, and are intended to describe this application and cannot be construed as a limitation to this application.

In the descriptions of this application, it should be understood that orientations or position relationships indicated by terms such as “length”, “width”, “above”, “below”, “front”, “back”, “left”, “right”, “vertical”, “horizontal”, “top”, “bottom”, “inside”, and “outside” are orientations or position relationships indicated based on the accompanying drawings, and are used merely for ease of describing this application and of simplified descriptions rather than for indicating or implying that an apparatus or a component must have a particular orientation or must be constructed or operated in a particular orientation, and therefore, cannot be construed as a limitation to this application.

In addition, terms “first” and “second” are used only for describing objectives, and shall not be construed as indicating or implying relative importance or implying a quantity of indicated technical features. Therefore, a feature restricted by “first” or “second” may explicitly indicate or implicitly include one or more such features. In the descriptions of this application, “a plurality of” refers to two or more, unless otherwise specifically limited in detail.

In the description of this application, it should be noted that, unless otherwise explicitly stipulated and restricted, terms “installation”, “joint connection”, “connection”, and “fixation” should be understood broadly, and for example, may be a fixed connection, or may be a detachable connection, or an integral connection; or may be a mechanical connection, or may be an electrical connection; or may be a direct connection, or may be an indirect connection by using a medium, or may be an internal connection between two components, or may be an interaction relationship between two components. A person of ordinary skill in the art can understand specific meanings of the foregoing terms in this application according to a specific situation.

A display apparatus provided by an embodiment of this application may include a display panel and a liquid crystal dimmer panel 30. The liquid crystal dimmer panel 30 is disposed on the display panel, and configured to adjust a light emitted by the display panel.

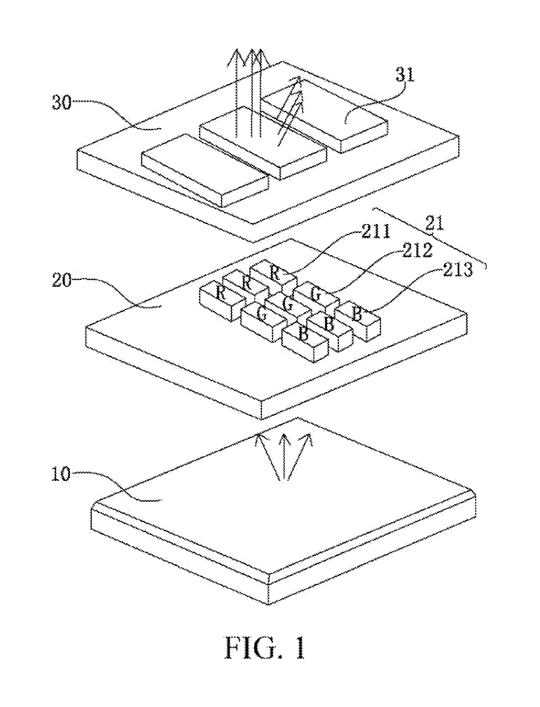

As shown in FIG. 1 to FIG. 3, the display apparatus provided by this embodiment of this application is, for example, an LCD, including a backlight module 10; an LCD panel 20 (display panel), where the LCD panel 20 and the backlight module 10 are disposed in a laminated manner, a plurality of image pixel groups 21 is disposed in arrays on the LCD panel 20, the image pixel group 21 includes a plurality of image pixels; and a liquid crystal dimmer panel 30, where the liquid crystal dimmer panel 30 and the LCD panel 20 are disposed in a laminated manner, and the LCD panel 20 is located between the backlight module 10 and the liquid crystal dimmer panel 30, and controls drive voltages of the liquid crystal dimmer panel 30 at locations relative to different image pixel groups 21, to control liquid crystal molecules in the liquid crystal dimmer panel 30 to perform viewing angle light energy adjustment.

In this embodiment, the LCD panel 20 may be a VA LCD panel 20, a twisted nematic (TN) LCD panel 20, an optically compensated birefringence (OCB) LCD panel 20, a curved surface display panel, or a COA type LCD panel, or may be a VA LCD panel 20 using no compensation film polarizer, a TN LCD panel 20 using no compensation film polarizer, or an OCB LCD panel 20 using no compensation film polarizer. In an actual application, one of the foregoing may be selected as the LCD panel 20 of the LCD. Certainly, in another embodiment of this application, alternatively, another type of liquid crystal panel may be selected as the LCD panel 20 of the LCD. This is not uniquely limited herein.

As shown in FIG. 1 to FIG. 3, in this embodiment, the plurality of image pixel groups 21 arranged in arrays on the LCD panel 20 may be red green blue (RGB) image pixel groups 21, white red green blue (WRGB) image pixel groups 21, or red green blue yellow (RGBY) image pixel groups 21. Certainly, the image pixel group 21 may be a combination of image pixels in other colors. This is not limited thereto. The RGB image pixel group 21 includes a red image pixel 211, a green image pixel 212, and a blue image pixel 213. Similarly, the WRGB image pixel group 21 includes a white image pixel, a red image pixel 211, a green image pixel 212, and a blue image pixel 213. The RGBY image pixel group 21 includes a red image pixel 211, a green image pixel 212, a blue image pixel 213, and a yellow image pixel. In addition, in this embodiment, a liquid crystal infusion technology used in the LCD panel 20 is the same as a liquid crystal infusion technology in the related art.

In a process of using the backlight module 10, the backlight module 10 is configured to provide backlight for illuminating the LCD panel 20. Drive voltages of the LCD panel 20 at locations of different image pixel groups 21 are controlled, to change an arrangement status of liquid crystal molecules in the LCD panel 20, so that the LCD panel 20 performs imaging. In this embodiment, because the liquid crystal dimmer panel 30 is disposed above the LCD panel 20 in a laminated manner, drive voltages of the liquid crystal dimmer panel 30 at locations relative to different image pixel groups 21 may be controlled, to change an arrangement status of liquid crystal molecules in the liquid crystal dimmer panel 30, so that the liquid crystal molecules in the liquid crystal dimmer panel 30 perform viewing angle light energy adjustment, thereby achieving an effect of homogeneous color from all viewing angles, resolving a problem of viewing angle color distortion of an LCD using a VA liquid crystal technology, and meeting application requirements in the market.

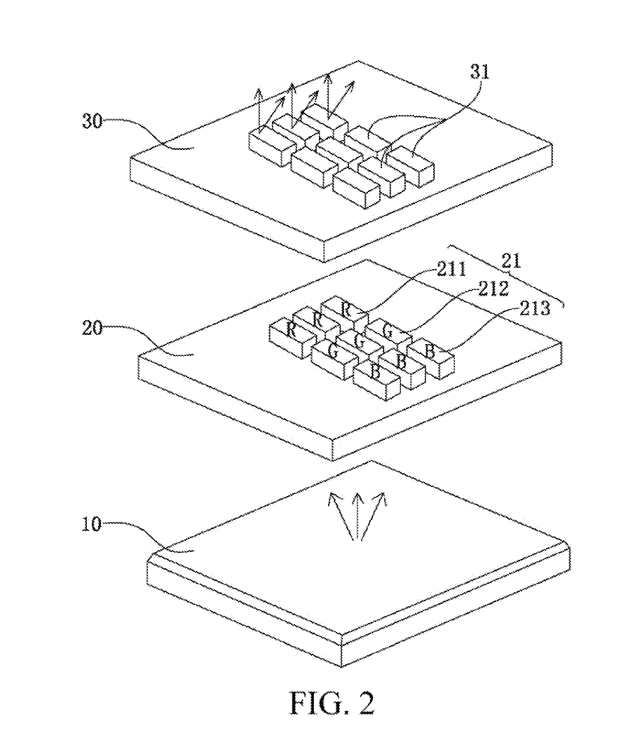

As shown in FIG. 1 and FIG. 2, further, a plurality of dimming pixels 31 is disposed on the liquid crystal dimmer panel 30, and the drive voltage is a drive voltage of each of the dimming pixels 31 on the liquid crystal dimmer panel 30. Each of the dimming pixels 31 on the liquid crystal dimmer panel 30 can be driven independently. A drive voltage of each of the dimming pixels 31 is controlled, so that an image displayed by the LCD can be accurately adjusted according to different viewing angle ranges, thereby achieving an effect of homogeneous color from all viewing angles, and improving user experience.

In this embodiment, the liquid crystal dimmer panel 30 may be, for example, a polymer dispersed liquid crystal (PDLC) array liquid crystal panel or another type of liquid crystal panel. The PDLC is obtained by mixing LC (low molecular liquid crystal) with a prepolymer Kuer UV65 glue, and after a polymerization reaction under certain conditions, liquid crystal microdroplets 352 in micrometer scale are formed and are evenly scattered in a network of high molecular polymers 351. Then a material having an electro-optic response property is obtained by using dielectric anisotropy of the liquid crystal molecules, and it mainly works between a scattering state and a transparent state and has a particular gray scale.

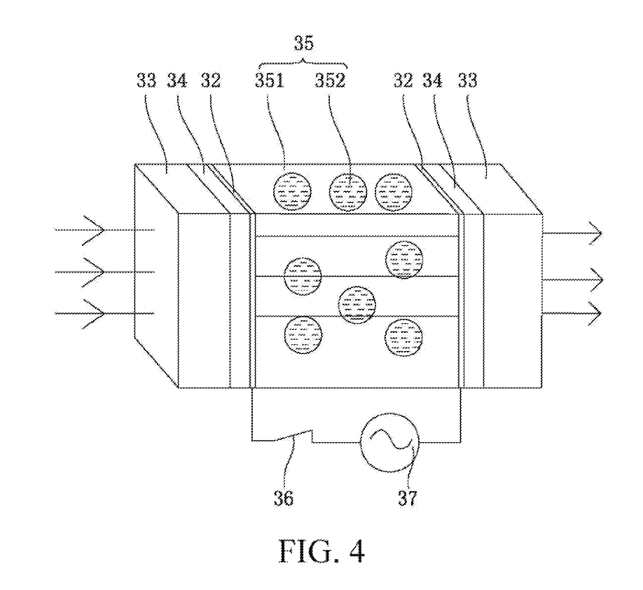

As shown in FIG. 4, when a switch 36 of a power 37 of the PDLC array liquid crystal panel is on, optical axes of the liquid crystal microdroplets 352 in the PDLC arrays liquid crystal panel are arranged perpendicular to a surface of a transparent conductive film, in a direction same as a field direction. In this case, an ordinary optical refractive index of the liquid crystal microdroplet 352 basically matches a refractive index of the polymer 351, and there is no obvious interface between the liquid crystal microdroplet 352 and the polymer 351. A PDLC layer 35 is a basically homogeneous medium. An incident light reaches the PDLC layer 35 after passing through a glass plate 33, an interlayer 34, and the transparent conductive film 32, and is then emitted after passing through the transparent conductive film 32 on the opposite side, the transparent conductive film 32, and the glass plate 33. The incident light does not scatter in the PDLC layer 35, and an emergent light thereof is emitted perpendicular to the glass plate 33. Therefore, the PDLC layer 35 is in a transparent state. In this way, a viewer can view colorful images from the front side of the LCD.

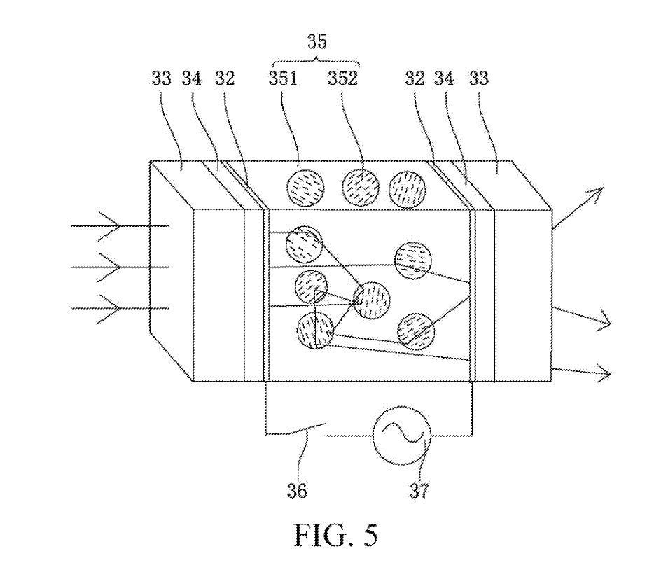

As shown in FIG. 5, when the switch 36 of the power supply 37 of the PDLC array liquid crystal panel is off, or a drive voltage controlling the PDLC array liquid crystal panel changes, the optical axes of the liquid crystal microdroplet 352 located in the PDLC array liquid crystal panel are in random directions, representing a disordered state. In this case, an effective optical refractive index of the liquid crystal microdroplet 352 does not match the refractive index of the polymer 351, no regular field can be formed in the PDLC layer 35, and an incident light is strongly scattered. The incident light is reflected or refracted in a plurality of directions for transmission in the PDLC layer 35 after passing through the glass plate 33, the interlayer 34, and the transparent conductive film 32, and is then emitted irregularly from a plurality of directions after passing through the transparent conductive film 32 on the opposite side, the transparent conductive film 32, and the glass plate 33. Therefore, the PDLC layer 35 is in an opaque state or a translucent state. In this case, the LCD panel 20 may perform viewing angle light energy adjustment according to different locations of viewers, so that front viewing angle energy of the LCD panel 20 is distributed to a large viewing angle, thereby ensuring that picture color and picture quality the same as those obtained from a front viewing angle can be presented at the location of the viewer.

As shown in FIG. 1, further, each of the dimming pixels 31 is disposed in a one-to-one correspondence with each image pixel group 21 on the LCD panel 20. Such a design can effectively reduce resolution of the liquid crystal dimmer panel 30, and can reduce a quantity of driving circuits and driving components on the liquid crystal dimmer panel 30, and increase luminous transmittance of the liquid crystal dimmer panel 30. Certainly, alternatively, each of the dimming pixels 31 may be disposed in correspondence with a plurality of adjacent image pixel groups 21 on the LCD panel 20. It should be further noted that such a pixel design is applicable to a case where an area of a local region of the dimming pixel 31 is large enough so that human eyes cannot identify chromaticity inhomogeneity between different local regions.

As shown in FIG. 2, further, each of the dimming pixels 31 is disposed in a one-to-one correspondence with each image pixel in the image pixel group 21. In this case, each of the dimming pixels 31, in the liquid crystal dimmer panel 30, disposed in a one-to-one correspondence with each image pixel on the LCD panel 20 can independently control driving, to appropriately compensate color rendering at locations of different color blocks on the LCD panel 20. The locations of the different color blocks on the LCD panel 20 may have a function of particularly intensifying local color rendering, to highlight high-saturation color rendering.

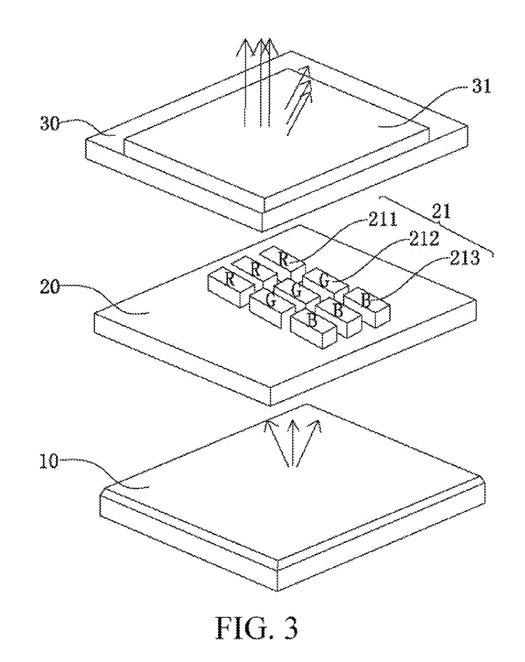

As shown in FIG. 3, further, a transparent conductive film 32 is disposed on both opposite surfaces of the liquid crystal dimmer panel 30, and drive voltages of the liquid crystal dimmer panel 30 at locations relative to different image pixel groups 21 are controlled by means of wiring of the transparent conductive film 32, to control liquid crystal molecules in the liquid crystal dimmer panel 30 to perform viewing angle light energy adjustment. The transparent conductive film 32 may be a metal transparent conductive film 32, made of Ag, Pt, Cu or Rh, or a transparent conductive film made by an oxide of In, Sn, Zn and Cd and a composite oxide thereof. Preferably, the transparent conductive film is an indium tin oxide (ITO) transparent conductive film. The ITO transparent conductive film has favorable luminous transmittance and electrical conductivity.

As shown in FIG. 1 to FIG. 3, further, the backlight module 10 provides backlight for the LCD panel 20, and the backlight is a collimated light illuminating the LCD panel 20. Preferably, in this embodiment, a viewing angle of the liquid crystal display with ⅓ brightness is less than 10°. For example, the viewing angle of the liquid crystal display with ⅓ brightness may be 2°, 4°, 6°, or 8°. Such a design can ensure that after a light emitted by the backlight module 10 passes through the LCD panel 20, positive light energy can still be maintained for the light, so that light energy can be effectively and properly distributed, thereby achieving an objective of saving energy. The viewing angle with ⅓ brightness refers to a viewing angle in a horizontal direction or in a vertical direction when brightness in the center of a screen is reduced to ⅓ of the maximum brightness.

In this embodiment, the backlight module 10 may include one or more luminous points. Preferably, when the backlight module 10 includes a plurality of luminous points, the plurality of luminous points is disposed in a one-to-one correspondence with each image pixel in the LCD panel 20, so that a collimated light radiated by each luminous point in the backlight module 10 can focus on and illuminate a corresponding image pixel in the LCD panel 20. In this way, for a light emitted from the LCD panel 20, positive light energy can be maintained, and light efficiency can be improved, thereby achieving an objective of effectively using the light energy.

Specifically, the luminous point of the backlight module 10 may be a bulb, an LED, a cold cathode fluorescent tube, a hot cathode fluorescent tube, an electro luminescence film, an organic electro luminescence (OEL) film, a flat fluorescent lamp, or the like. Certainly, in another embodiment of this application, another type of light emission source may be selected as the luminous point of the backlight module 10. This is not uniquely limited herein. In addition, in this embodiment, a corresponding spotlight component may further be disposed at each luminous point of the backlight module 10. The spotlight component may be a condensing lens, an optical film used for spotlighting, or the like. In this case, the luminous point of the backlight module 10 may optionally be a luminescent source of ordinary scattered lights. Scattered lights emitted by the luminescent source converge to form a collimated light after passing through the spotlight component, and then the collimated light illuminates the LCD panel 20.

Further, the LCD further includes a signal modem (not shown), configured to modulate/demodulate a picture signal received by the LCD, and a controller (not shown) electrically connected to the signal modem. The controller controls a drive voltage of the image pixel of the LCD panel 20 and a drive voltage of the dimming pixel 31 of the liquid crystal dimmer panel 30 according to the signal modulated/demodulated by the signal modem. After receiving a picture signal, the LCD modulates/demodulates the picture signal by using the signal modem. The modulated/demodulated signal is then transmitted to the controller. The controller controls, according to the signal, imaging by the LCD panel 20, and also controls the liquid crystal dimmer panel 30 to adjust color of a picture viewed from different viewing angle ranges, to resolve a problem of viewing angle color distortion of the LCD, so that viewers at different viewing angle locations can obtain an effect the same as an effect of a front viewing angle.

Further, the LCD further includes a human eye tracking apparatus (not shown) electrically connected to the controller and configured to track and determine a location of an eye of a viewer relative to the LCD. When a location of a viewer relative to the LCD changes, the human eye tracking apparatus can immediately capture the movement action of the viewer and detect information about a new location of the viewer relative to the LCD. The human eye tracking apparatus then transmits the detected information about the new location of the viewer relative to the LCD to the controller. The controller controls, according to the location information, a drive voltage of the liquid crystal dimmer panel 30, promptly adjusts a proportion of liquid crystal scattering to a light transmission degree of the polymer 351 in the liquid crystal dimmer panel 30, and provides light energy compensation amounts at different degrees for different viewing angle locations, to improve imaging quality after the location of the viewer changes, thereby achieving a display effect of no color distortion at any viewing angle location.

Further, the human eye tracking apparatus is a CCD location detection apparatus. A CCD is also referred to as an image controller or a CCD image sensor. The CCD location detection apparatus has advantages such as high resolution, high sensitivity, a wide dynamic range, a low image distortion degree, and a large light sensing area. Certainly, according to an actual situation and requirement, in another embodiment of this application, the human eye tracking apparatus may be any other device capable of implementing tracking and locating functions. This is not uniquely limited herein.

An embodiment of this application further provides a viewing angle color distortion mitigation method for an LCD, including the following steps:

providing a backlight module 10, an LCD panel 20, and a liquid crystal dimmer panel 30;

performing backlight illumination on an image pixel group 21 in the LCD panel 20 by using the backlight module 10; and

disposing the liquid crystal dimmer panel 30 on the LCD panel 20, and controlling drive voltages of the liquid crystal dimmer panel 30 at locations relative to different image pixel groups 21, to control liquid crystal molecules in the liquid crystal dimmer panel 30 to perform viewing angle light energy adjustment.

In the viewing angle color distortion mitigation method for an LCD provided by this embodiment of this application, because the liquid crystal dimmer panel 30 is disposed above the LCD panel 20 in a laminated manner, drive voltages of the liquid crystal dimmer panel 30 at locations relative to different image pixel groups 21 are controlled, to change an arrangement status of liquid crystal molecules in the liquid crystal dimmer panel 30, so that the liquid crystal molecules in the liquid crystal dimmer panel 30 perform viewing angle light energy adjustment, thereby achieving an effect of homogeneous color from all viewing angles, resolving a problem of viewing angle color distortion of an LCD using a VA liquid crystal technology, and meeting market requirements.

It should be further noted that directions indicated by arrows in FIG. 1 to FIG. 5 are illumination directions of lights.

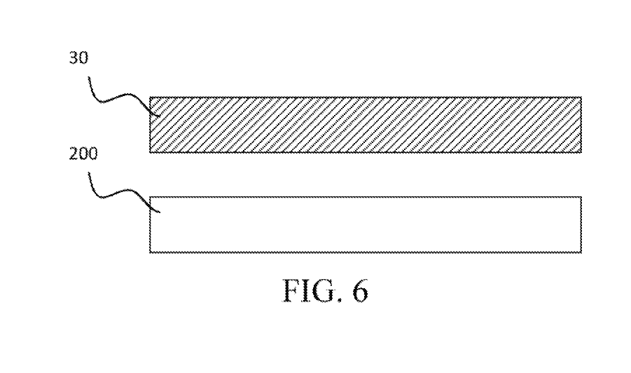

In different embodiments, as shown in FIG. 6, the liquid crystal dimmer panel 30 may be disposed on a display panel 200, for dimming. The display panel 200 may be an LCD panel, an OEL display panel, an OLED display panel, an LED display panel, a PDP, a field emission display panel, a carbon nanotube display panel, an e-ink display panel, a display panel using an electrochromic display (ECD) technology, or the like.

The foregoing descriptions are merely preferred embodiments of this application, but are not intended to limit this application. Any modification, equivalent replacement, or improvement made within the idea and principle of this application shall fall within the protection scope of this application.

What is claimed is:

1. A display apparatus, comprising:
a display panel, comprising a plurality of image pixels arranged in arrays; and
a liquid crystal dimmer panel, disposed on the display panel, wherein the liquid crystal dimmer panel has a transparent state and a scattering state, and in the transparent state, the liquid crystal dimmer panel allows an image of the image pixel to be directly viewed from the front side, and in the scattering state, the liquid crystal dimmer panel allows a light emitted by the image pixel to be refracted for adjustment.

2. The display apparatus according to claim 1, wherein a plurality of dimming pixels is disposed on the liquid crystal dimmer panel.

3. The display apparatus according to claim 2, wherein a drive voltage is a drive voltage of each of the dimming pixels on the liquid crystal dimmer panel.

4. The display apparatus according to claim 2, wherein each of the dimming pixels is disposed in a one-to-one correspondence with each image pixel group on the display panel.

5. The display apparatus according to claim 2, wherein each of the dimming pixels is disposed in a one-to-one correspondence with each image pixel in an image pixel group.

6. The display apparatus according to claim 1, wherein a transparent conductive film is disposed on both opposite surfaces of the liquid crystal dimmer panel.

7. The display apparatus according to claim 6, wherein drive voltages of the liquid crystal dimmer panel at locations relative to different image pixel groups are controlled by means of wiring of the transparent conductive film, to control liquid crystal molecules in the liquid crystal dimmer panel to perform viewing angle light energy adjustment.

8. The display apparatus according to claim 1, wherein the display panel is a liquid crystal display (LCD) panel.

9. The display apparatus according to claim 8, wherein a backlight module provides a backlight for the LCD panel.

10. The display apparatus according to claim 9, wherein the backlight is a collimated light illuminating the LCD panel.

11. The display apparatus according to claim 2, further comprising a signal modem, configured to modulate/demodulate a picture signal received by the display apparatus, and a controller electrically connected to the signal modem.

12. The display apparatus according to claim 11, wherein the controller controls a drive voltage of the image pixel of the display panel and a drive voltage of the dimming pixel of the liquid crystal dimmer panel according to the signal modulated/demodulated by the signal modem.

13. The display apparatus according to claim 11, further comprising a human eye tracking apparatus electrically connected to the controller and configured to track and determine a location of an eye of a viewer relative to the display apparatus.

14. The display apparatus according to claim 13, wherein the human eye tracking apparatus is a charge coupled device (CCD) location detection apparatus.

15. The display apparatus according to claim 1, wherein the display panel is an organic light-emitting diode (OLED) display panel.

16. The display apparatus according to claim 1, wherein the display panel is a light-emitting diode (LED) display panel.

17. The display apparatus according to claim 1, wherein the display panel is a plasma display panel (PDP).

18. The display apparatus according to claim 1, wherein the display panel is a field emission display panel.

19. The display apparatus according to claim 1, wherein the display panel is a carbon nanotube display panel, or an e-ink display panel.

20. A display apparatus, comprising:
a display panel, comprising a plurality of image pixels arranged in arrays; and
a liquid crystal dimmer panel, disposed on the display panel, wherein the liquid crystal dimmer panel has a transparent state and a scattering state, and in the transparent state, the liquid crystal dimmer panel allows an image of the image pixel to be directly viewed from the front side, and in the scattering state, the liquid crystal dimmer panel allows a light emitted by the image pixel to be refracted for adjustment, wherein
a plurality of dimming pixels is disposed on the liquid crystal dimmer panel, and a drive voltage is a drive voltage of each of the dimming pixels on the liquid crystal dimmer panel, wherein
a transparent conductive film is disposed on both opposite surfaces of the liquid crystal dimmer panel, and drive voltage of the liquid crystal dimmer panel at locations relative to different image pixel groups are controlled by means of wiring of the transparent conductive film, to control liquid crystal molecules in the liquid crystal dimmer panel to perform viewing angle light energy adjustment.
